(19) United States
(12) Patent Application Publication
(10) Pub. No.: US 2009/0089816 A1
(43) Pub. Date: Apr. 2, 2009

(54) DEVICE AND METHOD FOR EXECUTING KERNEL API INTERACTIVELY

(75) Inventors: Jeong Si KIM, Daejeon (KR); Duk Kyun Woo, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/099,455

(22) Filed: Apr. 8, 2008

(30) Foreign Application Priority Data
Oct. 1, 2007 (KR) 10-2007-0098678

(51) Int. Cl. G06F 9/54

(52) U.S. Cl. 719/328

(57) ABSTRACT

Provided are a device and method for executing a kernel application program interface (API) interactively in a Linux system, wherein a kernel API is independently operated in a user region to confirm an operation result. The device includes: a device interface unit for receiving a command from a user, and outputting an execution result corresponding to the command to the user; a kernel API command analysis unit for receiving the command from the device interface unit, analyzing the command, and generating kernel API execution information; and a kernel API command execution unit for executing a kernel API corresponding to the command using the kernel API execution information, and transmitting the execution result to the device interface unit. Thus, a kernel API can be applied using a simple process with reduced time and effort, instead of repeating the entire kernel program development process for a Linux system.

### CROSS-REFERENCE TO RELATED APPLICATION

This application claims priority to and the benefit of Korean Patent Application No. 2007-98678, filed Oct. 1, 2007, the disclosure of which is incorporated herein by reference in its entirety.

### BACKGROUND

1. Field of the Invention

The present invention relates to a device and method for executing a kernel application program interface (API) interactively ill a Linux system and, more particularly, to a device and method for executing a kernel API interactively, wherein the kernel API is independently operated in a user region to confirm all operation result.

This work was supported by the IT R&D program of MIC/IITA. [2005-S-086-02, Development of Automatic Code Generation Technology for Device Drivers].

2. Discussion of Related Art

In a conventional Linux system, a kernel program is an important program that constitutes essential system software, such as all operating system (OS) and a device driver, and operates in a kernel region that can access kernel and system resources. The kernel program may be made using a kernel application program interface (API), which is a group of routines and data structures that can be used for kernel programming. In general, the kernel API is necessarily required to process the main substance of the kernel program.

Referring to FIG. 1, a memory region of a Linux system is generally divided into a user region and a kernel region. A kernel program 120, which is made using a kernel API 130, is executed in a kernel region that call directly access system resources. On the contrary, an application program 110 that is executed in the user region cannot directly access the kernel region for security reasons, but indirectly process a task for the system resource using the kernel program 120, such as system calls, instead.

It is difficult to exactly apply a kernel API at once due to its complicated usage, and inexact, careless use of the kernel API may lead to a fatal result. For example, a system may need to be rebooted. Accordingly, the exact use of the kernel API imperatively requires a process of confirming the operation of the kernel API. However, since the kernel API operates in a kernel program, it is necessary to make a kernel program including the kernel API in order to confirm the operation of the kernel API.

Therefore, it takes considerable time and effort to confirm the operations of a plurality of kernel APIs in order to make a complicated kernel program including the plurality of kernel APIs. For instance, in a development environment of a typical kernel program provided by a Linux system, a user must repetitively perform the entire kernel program development process including operations of revising, building, and installing the entire kernel program with a plurality of kernel APIs in order to confirm if an arbitrary kernel API added to the kernel program exactly operates.

In order to reduce the complexity and difficulty of kernel programming, there is provided a technique of indirectly executing a device driver, one of kernel programs, using an application program that can be executed in a user mode. However, in the technique, since it is still difficult to access system kernel resources, it is hard to cover various processing substances of the device driver. Also, the device driver is processed using system calls, so that processing performance is degraded as compared with conventional device drivers using kernel APIs.

### SUMMARY OF THE INVENTION

The present invention is directed to a device and method for executing a kernel application program interface (API) interactively in a Linux system, wherein when a kernel API is selected and applied, the kernel API is independently operated in a user region without repeating the entire kernel program development process so that an operation result can be confirmed.

One aspect of the present invention provides a device for executing a kernel API interactively in a Linux system. The device includes: a device interface unit for receiving a command from a user, and outputting an execution result corresponding to the command to the user; a kernel API command analysis unit for receiving the command from the device interface unit, analyzing the command, and generating kernel API execution information; and a kernel API command execution unit for executing a kernel API corresponding to the command using the kernel API execution information, and transmitting the execution result to the device interface unit.

Another aspect of the present invention provides a method of executing a kernel API interactively in a Linux system. The method includes the steps of: analyzing a command received from a user to generate kernel API execution information; executing a kernel API corresponding to the command using the kernel API execution information; and outputting an execution result of the kernel API corresponding to the command.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 is a block diagram illustrating an environment of a Linux system in which a kernel application program interface (API) is executed according to a conventional method;

FIG. 2 is a block diagram illustrating an environment in which a kernel API interactive execution device operates according to all exemplary embodiment of the present invention;

FIG. 3 is a block diagram of a kernel API interactive execution device according to an exemplary embodiment of the present invention; and

FIG. 4 is a flow chart illustrating a method of executing a kernel API interactively according to an exemplary embodiment of the present invention.

### DETAILED DESCRIPTION OF EMBODIMENTS

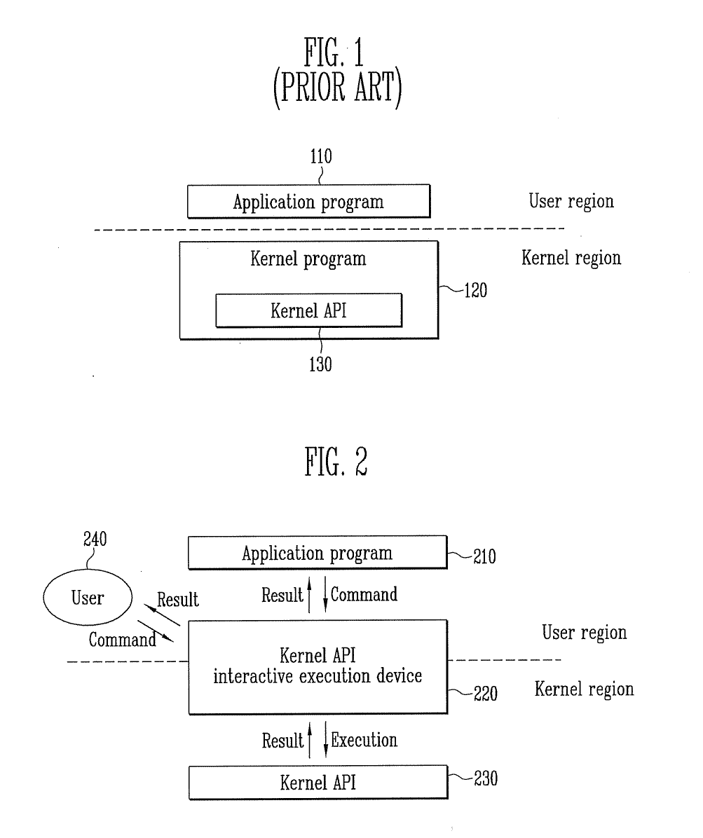

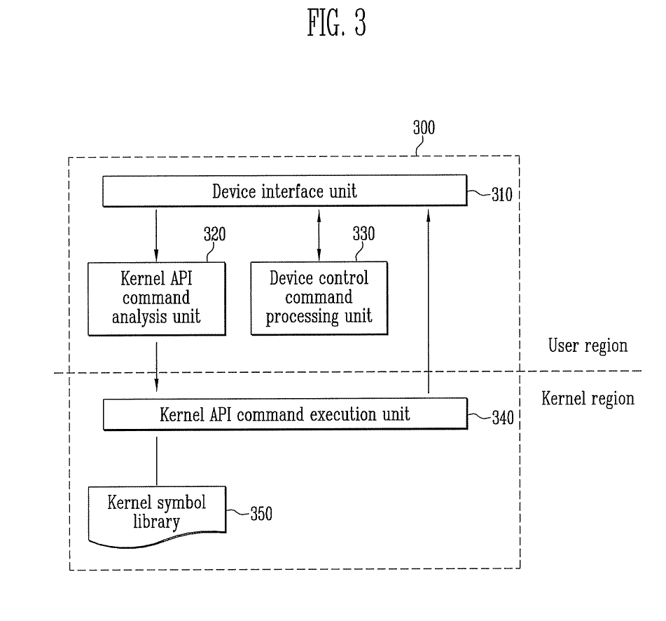

FIG. 2 is a block diagram illustrating an environment in which a kernel application program interface (API) interactive execution device operates according to an exemplary embodiment of the present invention.

Referring to FIG. 2, a kernel API interactive execution device 220 executes a kernel API 230 in a kernel region in response to a command received from a user region so that a user 240 can execute the kernel API 230 independently in the user region. The user 240 can executes the kernel API 230 through an application program 210 or directly using the kernel API interactive execution device 220 and can confirm an execution result. Thus, the user 240 can execute the kernel API 230 without making all additional kernel program and confirm if the kernel API 230 exactly operates.

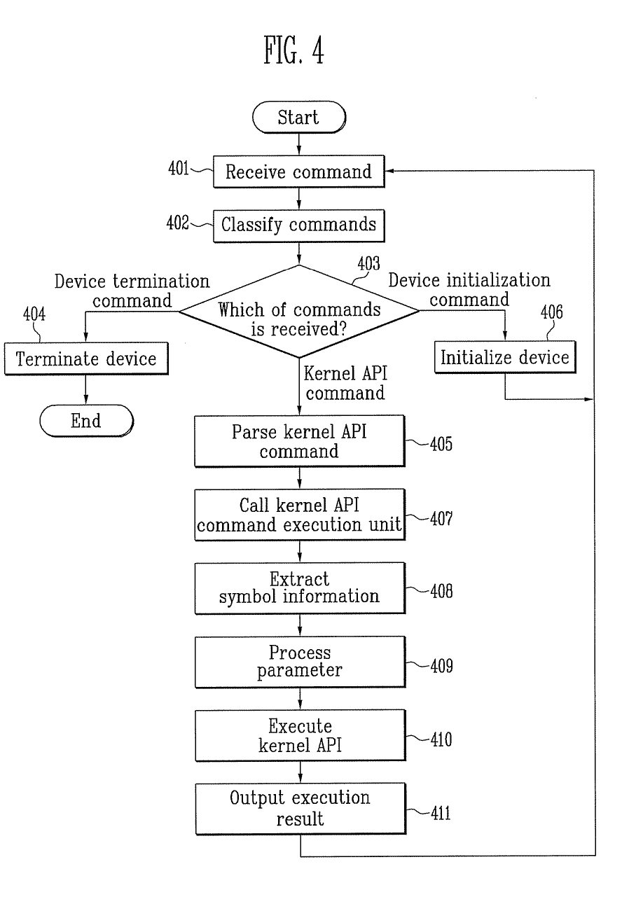

FIG. 3 is a block diagram of a kernel API interactive execution device according to an exemplary embodiment of the present invention.

Referring to FIG. 3, a kernel API interactive execution device 300 includes a device interface unit 310 functioning as an interface between the kernel API interactive execution device 300 and a user, a kernel API command analysis unit 320 for analyzing a command API command, a device control command processing unit 330 for processing a device control command, and a kernel API command execution unit 340 for executing the analyzed command API command.

Initially, the device interface unit 310 functions as an interface that receives a command from the user. Here, commands input through the device interface unit 310 may be classified into kernel API commands for executing a kernel API and device control commands for initializing or terminating the device. The device interface unit 310 classifies the received command into a kernel API command or a device control command, transmits the kernel API command and the device control command respectively to the kernel API command analysis unit 320 and the device control command processing unit 330, and requests the kernel API command analysis unit 320 or the device control command processing unit 330 to process the corresponding command. Also, the device interface unit 310 may receive an execution result of each kernel API command from the kernel API command execution unit 340 and output the execution result to the user.

The kernel API command analysis unit 320 receives a kernel API command from the device interface unit 310 and parses the received kernel API command into a kernel API name and a parameter. The kernel API command analysis unit 320 generates kernel API execution information including the kernel API name and the parameter. The kernel API command analysis unit 320 transmits the kernel API execution information to the kernel API execution unit 340 and requests the kernel API execution unit 340 to execute the kernel API.

The kernel API command execution unit 340 receives the kernel API execution information including the kernel API name and the parameter from the kernel API command analysis unit 320 and extracts symbol information corresponding to the kernel API name from a kernel symbol library 350. In this case, the kernel symbol library 350 may include not only the content of a symbol table, which is basically controlled in a kernel, but also symbol information, which is additionally provided by the device 300 according to the present invention. Furthermore, the kernel API command execution unit 340 processes the received parameter into appropriate data so as to execute the kernel API.

The kernel API command execution unit 340 executes the corresponding kernel API using the extracted symbol information and the processed parameter. In the present embodiment, the kernel API command execution unit 340 may be provided as the type of a kernel module in order to execute the kernel API in a kernel region.

The device control command processing unit 330 receives a device control command, such as a device initialization command or a device termination command, from the device interface unit 310 and controls the kernel API interactive execution device 300 in response to the device control command. In the present embodiment, the device control command processing unit 330 may initialize the kernel API command execution unit 340 and the kernel API command analysis unit 320 in response to a device initialization command.

FIG. 4 is a flow chart illustrating a method of executing a kernel API interactively according to an exemplary embodiment of the present invention.

Referring to FIG. 4, a device interface unit receives a command from a user in step 401. Thereafter, in step 402, the device interface unit analyzes the received command and determines if the command is a device initialization command, a device termination command, or a kernel API execution command.

When the received command is the device termination command, a device control command processing unit terminates a kernel API command execution unit and a kernel API command analysis unit to terminate a kernel API interface execution device in step 404.

When the received command is the device initialization command, the device control command processing unit initializes the kernel API command execution unit and the kernel API command analysis unit in step 406. Thereafter, the process enters step 401 and the device interface unit receives a new command.

When the received command is the kernel API execution command, the kernel API command analysis unit parses the kernel API execution command into a kernel API name and a parameter and generates kernel API execution information in step 405. Thereafter, the kernel API command analysis unit transmits the kernel API execution information including the kernel API name and the parameter to call the kernel API execution unit in step 407.

The kernel API command execution unit searches a kernel symbol library for symbol information corresponding to the kernel API name and extracts the symbol information in step 408, and processes the parameter into executable data using the symbol information in step 409. The kernel API command execution unit executes the kernel API using the symbol information and the processed parameter and transmits an execution result to the device interface unit in step 410. The device interface unit outputs the received result to the user in step 411. Thereafter, the process enters step 401 and receives a new command.

The above-described device and method for executing the kernel API interactively according to the invention can be embodied as computer readable codes on a computer readable recording medium. The computer readable recording medium is any data storage device that can store data which can be thereafter read by a computer system. Examples of the computer readable recording medium include read-only memories (ROMs), random-access memories (RAMs), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

According to the present invention as described above, a kernel API can be applied using a simple process with reduced time and effort, instead of repeating the entire kernel program development process for a Linux system.

In the drawings and specification, there have been disclosed typical preferred embodiments of the invention and, although specific terms are employed, they are used in a generic and descriptive sense only and not for purposes of limitation. As for the scope of the invention, it is to be set forth in the following claims. Therefore, it will be understood by those of ordinary skill in the art that various changes in form and details may be made therein without departing from the spirit and scope of the present invention as defined by the following claims.

What is claimed is:

1. A device for executing a kernel application program interface (API) interactively in a Linux system, the device comprising:
a device interface unit for receiving a command from a user, and outputting an execution result corresponding to the command to the user;
a kernel API command analysis unit for receiving the command from the device interface unit, analyzing the command, and generating kernel API execution information; and
a kernel API command execution unit for executing a kernel API corresponding to the command using the kernel API execution information, and transmitting the execution result to the device interface unit.

2. The device according to claim 1, wherein the kernel API execution information comprises a kernel API name and a parameter.

3. The device according to claim 2, wherein the kernel API command analysis unit parses the command into the kernel API name and the parameter in order to generate the kernel API execution information.

4. The device according to claim 2, wherein the kernel API command execution unit searches a kernel symbol library for symbol information using the kernel API name.

5. The device according to claim 4, wherein the kernel API command execution unit processes the parameter in order to execute the kernel API corresponding to the command.

6. The device according to claim 5, wherein the kernel API command execution unit executes the kernel API corresponding to the command using the symbol information and the processed parameter.

7. The device according to claim 1, wherein the kernel API command execution unit comprises a kernel module.

8. The device according to claim 1, further comprising a device control command execution unit for initializing or terminating the kernel API command analysis unit and the kernel API command execution unit in response to the command.

9. A method of executing a kernel application program interface (API) interactively in a Linux system, the method comprising:
analyzing a command received from a user to generate kernel API execution information;
executing a kernel API corresponding to the command using the kernel API execution information; and
outputting an execution result of the kernel API corresponding to the command.

10. The method according to claim 9, wherein the kernel API execution information comprises a kernel API name and a parameter.

11. The method according to claim 10, wherein the analyzing the command received from the user comprises parsing the command into the kernel API name and the parameter.

12. The method according to claim 11, wherein the executing the kernel API comprises:
searching a kernel symbol library for symbol information using the kernel API name;
processing the parameter; and
executing the kernel API corresponding to the command using the symbol information and the processed parameter.

13. The method according to claim 9, wherein the executing the kernel API is performed by a kernel API execution unit including a kernel module.
